(19) United States
(12) Patent Application Publication
(10) Pub. No.: US 2021/0256544 A1
(43) Pub. Date: Aug. 19, 2021

(54) ADAPTION OF CLOUD TECHNOLOGY IN DIGITAL ADVERTISEMENT

(71) Applicant: VEGGA APPSOL PRIVATE LIMITED, Vijayawada (IN)

(72) Inventors: SYAMA SUBBARAO YELLAPRAGADA, Hyderabad (IN); RAJA RAMESH KUMAR DUDDUPUDI, Kovvur (IN)

(21) Appl. No.: 16/634,162

(22) PCT Filed: Oct. 9, 2019
(86) PCT No.: PCT/IB2019/058599

§ 371 Date: Jan. 27, 2020

(30) Foreign Application Priority Data
Oct. 9, 2018 (IN) 201841013580

(51) Int. Cl. G06Q 30/02

(52) U.S. Cl. CPC G06Q 30/0203; G06Q 30/0277; H04L 63/08; G06Q 30/0201; G06Q 30/0218; G06Q 30/0248

(57) ABSTRACT

Exemplary embodiments of the present disclosure are directed towards a system for achieving viewer response/acknowledgement based digital advertising using the cloud service platform, comprising: computing devices connected with an advertisement viewership application module through a communication network, the advertisement viewership application module receives requests from the computing devices and the advertisement viewership application module comprises I/O interface configured to receive input data from the computing devices through the communication network, the advertisement viewership application module configured to display digital contents on the computing devices, the advertisement viewership application module configured to provide questions associated with digital contents based on the authentication of the users and receives answers for the question from the users and checks for the correctness of the answers; and a memory configured to store the information received from the I/O interface and the memory communicatively coupled to the processor of the advertisement viewership application module.

### TECHNICAL FIELD

The disclosed subject matter generally relates to a cloud service platform, but exclusively relate to method and system for achieving viewer response/acknowledgement based digital advertising for an advertisement application using the cloud service platform.

### BACKGROUND

At present, digital advertisement in day to day business and economical state of current affairs do not guarantee the viewership for any business entity or individual to implement operational excellence. The current business strategies dealing with marketing and advertisement have limitations, such as, digital advertisement and cloud management are not the end products, no guaranteed viewership for the products advertised, enormous cost involved in hiring third party marketing houses, technology usage is primitive, and mobile application-based advertisements. There are four major mobile advertising formats that marketers run ad campaign namely banner, interstitial, video and native.

Each of these, influence mobile users experience differently. Banner and especially Interstitial are more intrusive. A number of app-based advertisements or ads operate through a similar arrangements as traditional web advertisement. Developers join ad networks that sell off advertising space in apps to advertisers, who buy spots that will reach target demographics. The existing technologies do not provide any guarantee that the user views the advertisement.

In the light of the aforementioned discussion, there exists a need for system with novel methodologies that will overcome the above-mentioned challenges.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and for achieving viewer response/acknowledgement based digital advertising for an advertisement application using the cloud service platform.

An objective of the present disclosure is directed towards reaching out people with easy intuitive branding carrier with multi language support so that everyone can operate using a smart phone or watch.

Another objective of the present disclosure is directed towards getting awareness to the people regarding government projects/schemes, non-government organizations, and private organizations through the advertisements.

Another objective of the present disclosure is directed towards the system to extend the advertisements from being a mere 2 seconds or 5 seconds pop disturbances to being a contest with a useful interaction part in a way that it is fun and rewarding to consumers and product owners.

Another objective of the present disclosure is directed towards the system to motivate the users/consumers to answer the questions based on the advertisement video/slide/picture and earn the rewards from manufacturers directly that which leads to discussions and communications and therefore guarantees not just the viewership but also increases consumer understanding of using better products that fit their needs.

Another objective of the present disclosure is directed towards the system to guarantee the manufacturers of viewership of their advertisements and support them in making higher business and operational excellence decisions based on the reports and data provided by the system.

Another objective of the present disclosure is directed towards the system to make an advertisement as a program and make the advertisement to benefit consumers with latest and better products.

Another objective of the present disclosure is directed towards the system to motivate the consumers to view the complete advertisement to get benefit directly.

Another objective of the present disclosure is directed towards the system to provide dynamic ranking for the number of questions answered by each user being displayed on screen and, rewarding them.

According to an exemplary aspect, the system comprising plurality of computing devices connected with an advertisement viewership application module through a communication network, the advertisement viewership application module receives a plurality of requests from the plurality of computing devices and the advertisement viewership application module comprises at least one I/O interface configured to receive one or more input data from the plurality of computing devices through the communication network.

According to another exemplary aspect, the advertisement viewership application module configured to display one or more digital contents on the plurality of computing devices, the advertisement viewership application module configured to provide a plurality of questions associated with one or more digital contents based on the authentication of the plurality of users and receives a plurality of answers for the question from the plurality of users and checks for the correctness of the plurality of answers.

According to an exemplary aspect, the system comprising at least one memory configured to store the information received from the at least one I/O interface and the at least one memory communicatively coupled to the at least one processor of the advertisement viewership application module.

### BRIEF DESCRIPTION OF THE DRAWINGS

FIG. 1 illustrates an exemplary environment for displaying digital content to record viewership in a communication network, in accordance with one or more exemplary embodiments.

FIG. 2 shows a detailed block diagram of an advertisement viewership application system, in accordance with one or more exemplary embodiments.

FIG. 3 illustrates a flowchart showing a method for recording viewership, in accordance with one or more exemplary embodiments.

FIG. 4 illustrates a flowchart showing a method for recording viewership, in accordance with one or more exemplary embodiments.

FIG. 5 is a flowchart depicting an exemplary method for Sending notifications to the authorized user at a predetermined time period, in accordance with one or more exemplary embodiments.

FIG. 6 is a flowchart depicting an exemplary method for sending dashboards/reports to respective advertisers from the advertisement viewership application module, in accordance with one or more exemplary embodiments.

FIG. 7 is a flowchart depicting an exemplary method for getting the acknowledgement of fund transfer from the digital payment wallets to the user, in accordance with one or more exemplary embodiments.

FIG. 8 is a flowchart depicting an exemplary method for displaying the status on the computing device, in accordance with one or more exemplary embodiments.

FIG. 9 is a flowchart depicting an exemplary method for publishing the live content on the computing device, in accordance with one or more exemplary embodiments.

FIG. 10 is an example system architecture, in accordance with one or more exemplary embodiments.

FIG. 11A-FIG. 11B are example diagrams depicting login and registration screens, in accordance with one or more exemplary embodiments.

FIG. 11C is an example diagram depicting a welcome bonus screen, in accordance with one or more exemplary embodiments.

FIG. 11D is an example diagram depicting the invite friend screen, in accordance with one or more exemplary embodiments.

FIG. 11E, FIG. 11F, FIG. 11G are example diagrams depicting total reward screen and advertisement screens, in accordance with one or more exemplary embodiments.

FIG. 11H, FIG. 11I, FIG. 11J, FIG. 11K are example diagrams depicting question screens and result screen, in accordance with one or more exemplary embodiments.

FIG. 11L, FIG. 11M are example diagrams depicting redeem point screens, in accordance with one or more exemplary embodiments.

FIG. 11N is an example diagram depicting a multi-language support screen, in accordance with one or more exemplary embodiments.

FIG. 11O, FIG. 11P are example diagrams depicting winning screens, in accordance with one or more exemplary embodiments.

FIG. 12 is an example diagram depicting the real time cumulative figures dashboard screen, in accordance with one or more exemplary embodiments.

FIG. 13 is an example diagram depicting the views region wise screen, in accordance with one or more exemplary embodiments.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and so forth, herein do not denote any order, quantity, or importance, but rather are used to distinguish one element from another.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure are related, in general to cloud and digital technologies, but exclusively relate to method and system for achieving viewer response based digital advertising for an advertisement application. The advertisement may use cloud service platform. This is used to extend the advertisements from being viewed from a mere 2 seconds or 5 seconds pop up disturbances to a game with a useful user interaction or a quiz which provide user entertainment/fun and thereby, rewarding the user or consumers and product owners.

A user, also referred as a player or consumer are motivated to answer questions based on digital content displayed i.e., an advertisement video or slide or picture and thereby earn rewards from manufacturers directly. Thus, the digital content viewership is not only guaranteed but also increases consumer understanding of using better products that may fit their needs and requirements.

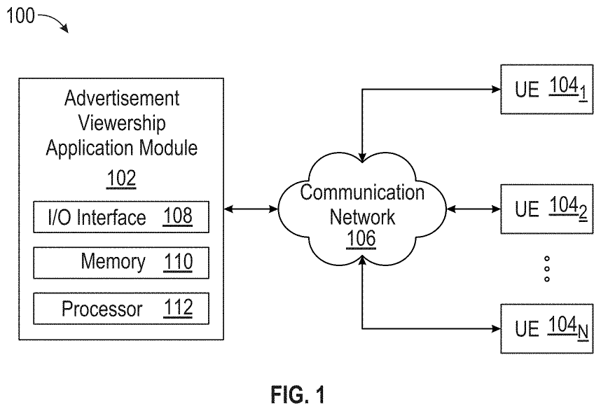

FIG. 1 illustrates an exemplary environment for displaying digital content to record viewership in a communication network, in accordance with an embodiment of the present disclosure;

As shown in FIG. 1, an environment 100 comprises an advertisement viewership application system 102 connected with a plurality of user equipment's (UE) 1041 1042, . . . , 104N, collectively referred as 104, through a communication network 106. The advertisement viewership application system 102 may be a server. The UE 104, also referred as a user device, may be a mobile device, a tablet, a smartphone, a laptop, a desktop computer, a Personal Digital Assistant (PDA), a notebook, a server, and any other computing devices. A person skilled in the art would understand that, any other devices, not mentioned explicitly, may also be used as the advertisement viewership application system 102 and the UE 104 in the present disclosure.

The communication network 106 may include, but is not limited to, a direct interconnection, an internet of things (IoT network devices), an Ethernet, a wireless local area network (WLAN), or a wide area network (WAN), an e-commerce network, a Peer to Peer (P2P) network, Local Area Network (LAN), wireless network (e.g., using Wireless Application Protocol), Internet, a Bluetooth low energy network, a ZigBee network, a WWI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

The advertisement viewership application system 102 may comprise an I/O interface 108, a memory 110 and a processor 112. The advertisement viewership application system 102 may receive a plurality of requests from the UEs 104 (104_1, 104_2 . . . 104_N), also referred as mobile devices or user device, through the communication network 106.

In an embodiment, the requests may refer to a data transmitted from the plurality of UEs104. In an embodiment, the data may be associated with user registration, user authentication, and any type of data such as, audio, video, emails, documents and the like.

The I/O interface 108 may be configured to receive the one or more input data from a UE104_1 of the plurality of UEs104, through the communication network 106. The information received from the I/O interface 108 may be stored in a memory 110. The memory 110 may be communicatively coupled to the processor 112 of the advertisement viewership application system 102. The memory 110 may also store processor instructions which may cause the processor 112 to execute the instructions for obtaining viewership associated with the digital content.

Each of the UEs104 are configured with an application module associated with the advertisement viewership application system 102. To guarantee manufacturers of viewership for associated advertisements and support for manufactures higher business and operational excellence decisions, reports associated with viewership of the digital content or advertisement are provided using the mobile application. The application module, also referred as mobile application, associated with the advertisement viewership application system 102, configured in the UEs104 make an advertisement as a program and make it house hold mobile application to benefit consumers with latest and better products. This motivates consumers to view the complete digital content or advertisement, so could they benefit directly. The application module provides dynamic ranking for the number of questions answered by each end user being displayed on screen and rewarding the end user.

The application module or mobile application is also referred as AdVin, may be configured on any of the operating system (OS), such as but not limited to android, windows, Linux, IOS platform and any OS supported devices. The advertisement viewership application system 102 and the application module are configured and supported by cloud computing, e-wallet, amazon web services, web/mobile technologies, PayPal payment gateway & IoT, frameworks such as spring, jersey, angularJS, node.js, python, big data et and, tools such as JIRA, Jenkins, Git, Objective-C and Swift and application lifecycle management (ALM).

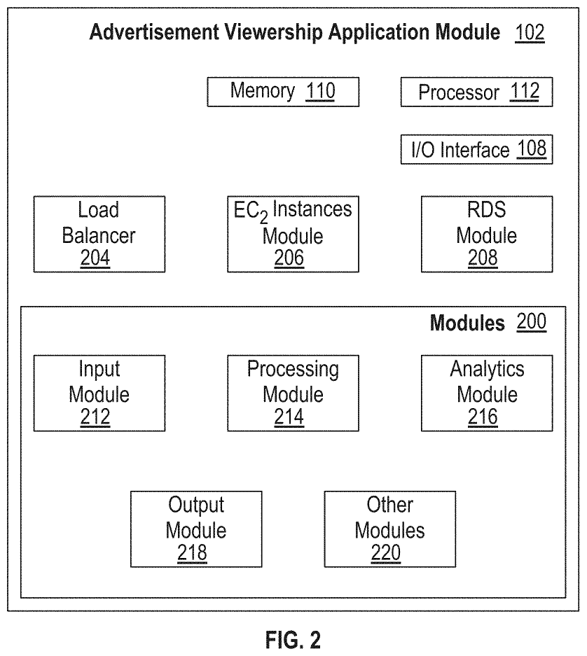

FIG. 2 shows a detailed block diagram of an advertisement viewership application system, in accordance with an embodiment of the present disclosure.

As shown in FIG. 2, the advertisement viewership application system 102 comprises the I/O interface 108, the memory 110, the processor 112, a load balancer 204, elastic compute cloud (EC2) instances module 206, and relational database service (RDS) module 208. In one implementation, the advertisement viewership application system 102 may comprise modules 200 for performing various operations in accordance with the embodiments of the present disclosure.

The modules 200 includes an input module 212, a processing module 214, an analytics module 216, an output module 218, and other modules 220.

The load balancer 204, may be an amazon webservices (AWS) elastic load balancer, configured to balance a traffic on the advertisement viewership application system 102, which is controlling the number of users using the application module, associated with user mobile devices, to access the advertisement viewership application system 102.

The application module, associated with the user mobile device may be accessed from the EC2 instances module 206. The EC2 instances module 206 is a virtual server in Amazon's EC2 for running applications on the amazon web services (AWS) infrastructure. The RDS module 208 is a relational database in the cloud, to provide efficient and resizable capacity while automating time-consuming administration tasks such as hardware provisioning, database setup, patching and backups.

The input module 212 is configured to receive input data from a plurality of users' i.e. mobile devices 104. The input data comprises at least one of user registration data, user authenticity, user selected data, user answers to questions display on the mobile device and any other user data. The processing module 214 processes the user input data and provides at least one of registration, authenticity, checking the correctness of answers to the questions, and verifying any data associated with a user. The analytics module 216 provides analytics associated with the user data. The output module 218 provide an output to the users i.e. UEs104. The output includes displaying digital content or advertisements, questions, continuing questions, reward to the users and any other output associated with the advertisement viewership application system 102.

A user upon configuring the application module, on the associated user device, will be played with an advertisement i.e. a video or a slide or a picture for full length play time, given by the manufacturer without having the facility to skip the advertisement and move forward to the game. The game is a quiz game, i.e. questions are asked on the advertisement video/slide/picture played, in an embodiment. All the questions are multiple choice questions or questions with plain text answers. At a given time any number of users can participate in the game and have the chance of becoming winners, upon answering all the questions. A display dynamic statistic for each user based on different number of advertisements a user has watched and played the subsequent games, and the score accumulated at the end of the game.

In an embodiment, each user has to go through a registration process before starting of the questions, in an embodiment. A user upon downloading and configuring the mobile application or application module, receives a registration form from the server is needed to be filled in. The server then provides the form. The user inputs data and submits the form. The advertisement viewership application system 102 i.e. the server checks the form to ensure the data given in the form does not violate any constraints. The server updates the database and notifies the user about the progress. Upon successful registration, the user gets bonus reward points that are equivalent to the currency of a nation.

After the user is registered with the advertisement viewership application system, the user authentication is performed. When the user registers during download, at that time the details of the user are validated. The provided details will then be verified with the values in database and the result will be calculated according to the match criteria. Then the result will be shown on the screen. The user requests for authentication to the server. Server checks the database, which may be modified by the user, also referred as client. On successful authentication, the server initializes the client. If authentication fails, the user is notified to check the data or to register again.

In an embodiment, the authorized registered users only can access associated details with the advertisement viewership application system 102. The users can login by using associated user identification (ID) and password and view their statistics. Thus, a database associated with users is created in the advertisement viewership application system 102.

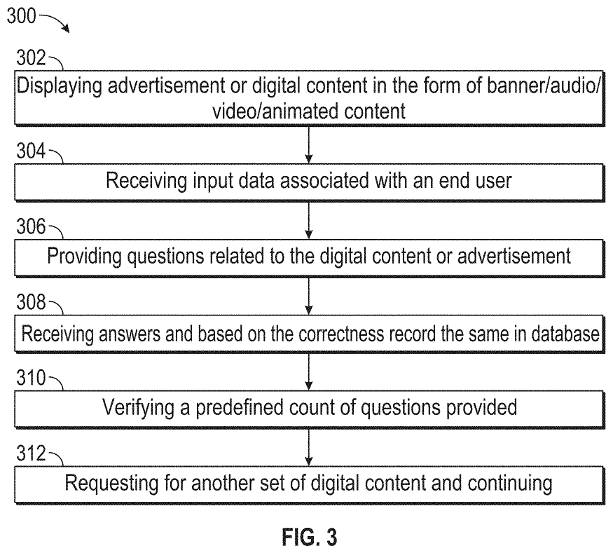

FIG. 3 illustrates a flowchart showing a method for recording viewership associated with advertisement using the advertisement viewership application system, in accordance with an embodiment of present disclosure.

As illustrated in FIG. 3, the method 300 includes one or more blocks for recording viewership associated with advertisement in a communication network. The method 300 may be described in the general context of computer executable instructions. Generally, computer executable instructions can include routines, programs, objects, components, data structures, procedures, modules 200, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the advertisement viewership application system displays advertisement or digital content in the form of banner/audio/video/animated content on a user device. The user device is configured with an application module corresponding to the advertisement viewership application system.

At block 304, the end user inputs data for authentication, which is verified by the advertisement viewership application system 102. The end user may include, but not limited to, mobile user, player or consumer, and so forth.

At block 306, the advertisement viewership application system 102 provides questions or conducts quiz game, related to the digital content or advertisement, this is based on the authentication of the end user.

At block 308, the advertisement viewership application system 102 receives answers for the question from the end user and checks for the correctness of the answers.

At block 310, the advertisement viewership application system 102 verifies or checks the number of questions provided or asked with the end user.

At block 312, based on the verification, requests the end user to continue the questions i.e. quiz. Based on the input received, the advertisement viewership application system 102 continues the questioning.

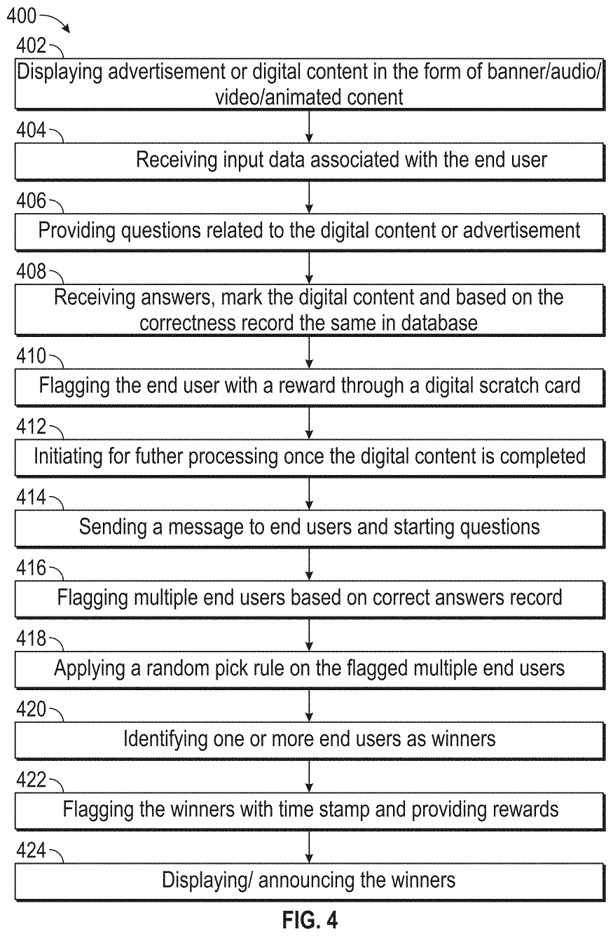

FIG. 4 illustrates a flowchart showing a method for recording viewership associated with advertisement using the advertisement viewership application system, in accordance with another embodiment of present disclosure.

As illustrated in FIG. 4, the method 400 includes one or more blocks for recording viewership associated with advertisement in a communication network. The method 400 may be described in the general context of computer executable instructions. Generally, computer executable instructions can include routines, programs, objects, components, data structures, procedures, modules 200, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 402, the advertisement viewership application system displays advertisement or digital content in the form of banner/audio/video/animated content on the user device. The user device is configured with an application module corresponding to the advertisement viewership application system.

At block 404, receives the input from the user device for authentication, which is verified by the advertisement viewership application system 102.

At block 406, the advertisement viewership application system 102 provides random questions or conducts quiz game, related to the digital content or advertisement, this is based on the authentication of the end user.

In an embodiment, the questions provided to the end user or quiz game chooses the questions on a random basis for each end user or player by the following steps:

Each end user or player has a level-based approach and one or more categories assigned and therefore end user will only get questions, which are equal to their level of current game and are within the assigned categories. During one game the same question must not be chosen more than once. Every question has an importance level related to the Advertisement shown before the quiz. The importance level of the question is the source for calculating the User game level. If the end user answers all the questions the User game level for that user is incremented. In particular, if the user answers the question correctly, the User level is incremented with 1, if the user answers the question incorrectly, the User level is incremented only with 0 (which leads to a higher chance the user will be asked the same question again in after 10th runtime of same advertisement in future). The other user who are participating simultaneously in the same quiz will not know the answers chosen by another user. Every question can be either a multiple-choice question or a question consisting of plain text. Each question has different answers assigned, which can be correct (Is Correct=true) or can be incorrect (Is Correct=false, used for wrong multiple-choice answers). Display individual user wise statistics per user and that different statistics for each user is displayed (number of advertisements viewed, related number of games played, correct/wrong answered question, hits per game, sum of played games, score per game and overall scorecard).

At block 408, the advertisement viewership application system 102 receives answers for the question from the end user and checks for the correctness of the answers.

At block 410, the advertisement viewership application system 102 flags the end user based on the correctness of the answers i.e. the end user is provided with rewards or reward points. The end user may get 100 bonus points (or as decided time to time) into user dashboard upon registration, while downloading. Each point is equivalent of a currency value. For example, may be INR 1, in an embodiment. Every set of games or a game, played completely by answering all the questions correctly will earn them sum agreed or business mentioned bonus points to associated user dashboard. The accumulated bonus points are redeemable to any predefined mobile wallet such as, but not limited to, Pay™ or UPI or other convertible secured resources.

At block 412, the advertisement viewership application system 102 verifies or checks the predefined time. The predefined time may be 18:00 hours, in an embodiment. The predefined time may be 20:00 hours or 22:00, in another embodiment.

At block 414, based on the verification of time, requests the end user to continue the questions i.e. quiz. Based on the input received, the advertisement viewership application system 102 continues the questioning.

At block 416, the advertisement viewership application system 102 flags multiple end users based on the correctness of the answers provided for the question provided.

At block 418, the advertisement viewership application system 102 applies a predefined logic or rule i.e. 10% or 30%.

At block 420, based on the predefined rule logic the advertisement viewership application system 102 identifies one or more users as winners.

At block 422, the advertisement viewership application system 102 flags the one or more winners.

At block 424, the advertisement viewership application system 102 display or announces the one or more winners.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

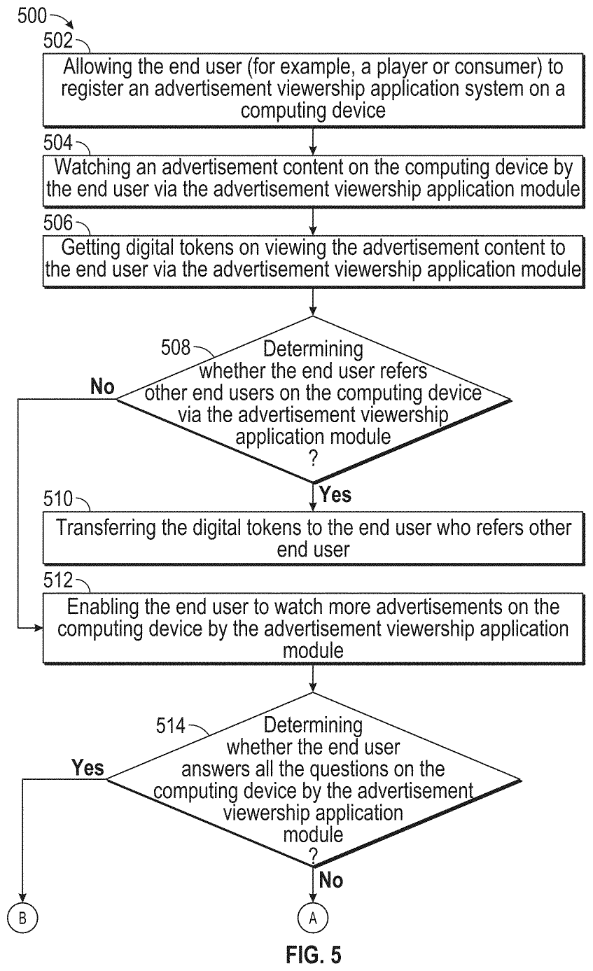

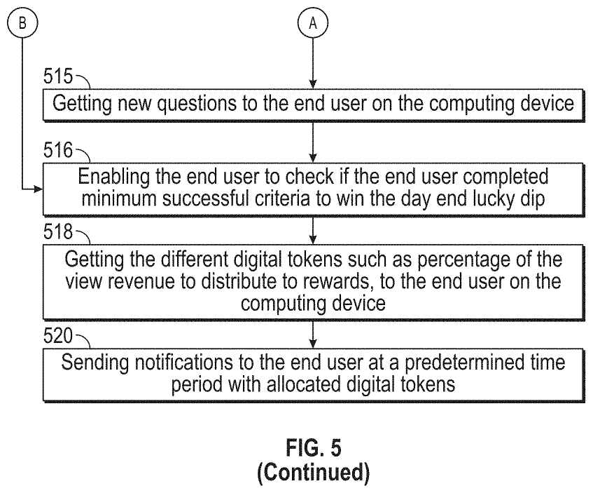

Referring to FIG. 5 is a flowchart 500 depicting an exemplary method for sending notifications to the end user at a predetermined time period, in accordance with one or more exemplary embodiments. As an option, method 500 is carried out in the context of the details of FIG. 1, FIG. 2, and FIG. 3, and FIG. 4. However, method 500 is carried out in any desired environment. Further, the aforementioned definitions are equally applied to the description below.

The method commences at step 502, the advertisement viewership application module allows the end user to register the viewership. At step 504, the end user watches the advertisement content on the computing device via the advertisement viewership application module. At step 506, the end user gets the digital tokens on viewing the advertisement content via the advertisement viewership application module. At step 508, Determine whether the end user refers other end users on the computing device via the advertisement viewership application module. If answer to step 508 is YES, then the method continues at step 510, the advertisement viewership application module transfers the digital tokens to the end user who refers other end user on the computing device. If answer to step 508 is NO, then the method continues at step 512, the advertisement viewership application module enables the end user to watch more advertisements on the computing device. At step 514, determine whether the end user answers all the questions on the computing device via the advertisement viewership application module. If answer to step 514 is NO, then the method continues at step 512. If answer to step 514 is YES, then the method continues at step 516, the advertisement viewership application module enables the end user to win the day end lucky dip. At step 518, the end user get the different digital tokens such as net day's installation revenue, day's view revenue, percentage of the view revenue to distribute to rewards on the computing device. At step 520, the advertisement viewership application module sends notifications to the end user at a predetermined time period with allocated digital tokens.

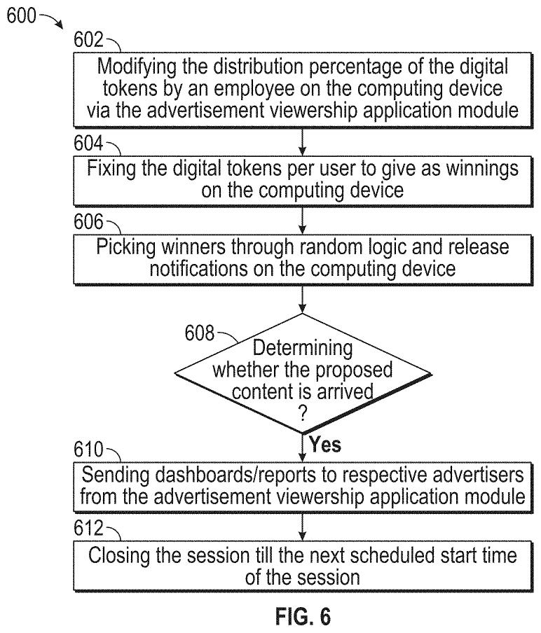

Referring to FIG. 6 is a flowchart 600 depicting an exemplary method for sending dashboards/reports to respective advertisers from the advertisement viewership application module, in accordance with one or more exemplary embodiments. As an option, method 600 is carried out in the context of the details of FIG. 1, FIG. 2, and FIG. 3, and FIG. 4. However, method 600 is carried out in any desired environment. Further, the aforementioned definitions are equally applied to the description below.

At step 602, the employee modifies the distribution percentage of the digital tokens on the computing device via the advertisement viewership application module. At step 604, the digital tokens are fixed per user to give as winnings on the computing device. At step 606, the advertisement viewership application module picks winners through random logic and release notifications on the computing device. At step 608, determine whether the proposed content is arrived. If answer to step 608 is YES, at step 610, the advertisement viewership application module sends dashboards/reports to respective advertisers. At step 612, the session may be closed till the next scheduled start time of the session.

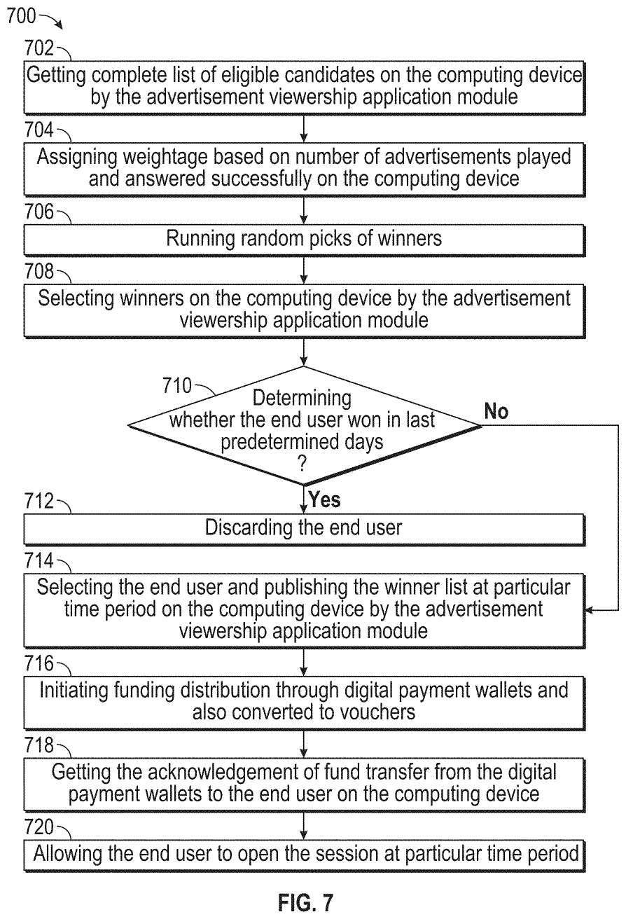

Referring to FIG. 7 is a flowchart 700 depicting an exemplary method for getting the acknowledgement of fund transfer from the digital payment wallets to the end user, in accordance with one or more exemplary embodiments. As an option, method 700 is carried out in the context of the details of FIG. 1, FIG. 2, and FIG. 3, FIG. 4, FIG. 5, and FIG. 6. However, method 700 is carried out in any desired environment. Further, the aforementioned definitions are equally applied to the description below.

At step 702, the computing device gets the complete list of eligible candidates by the advertisement viewership application module. At step 704, the advertisement viewership application module assigns weightage based on number of advertisements played and answered successfully on the computing device. At step 706, the advertisement viewership application module runs random picks of winners. At step 708, advertisement viewership application module selects winners on the computing device. At step 710, determine whether the end user won in last predetermined days. If answer to step 710 is YES, at step 712, discard the end user. If answer to step 710 is No, at step 714, the advertisement viewership application module selects the end user and publishes the winner list at particular time period on the computing device. At step 716, the advertisement viewership application module initiates funding distribution through digital payment wallets and also converted to vouchers. At step 718, the computing device gets the acknowledgement of fund transfer from the digital payment wallets to the end user on the computing device. At step 720, the end user allows to open the session at particular time period.

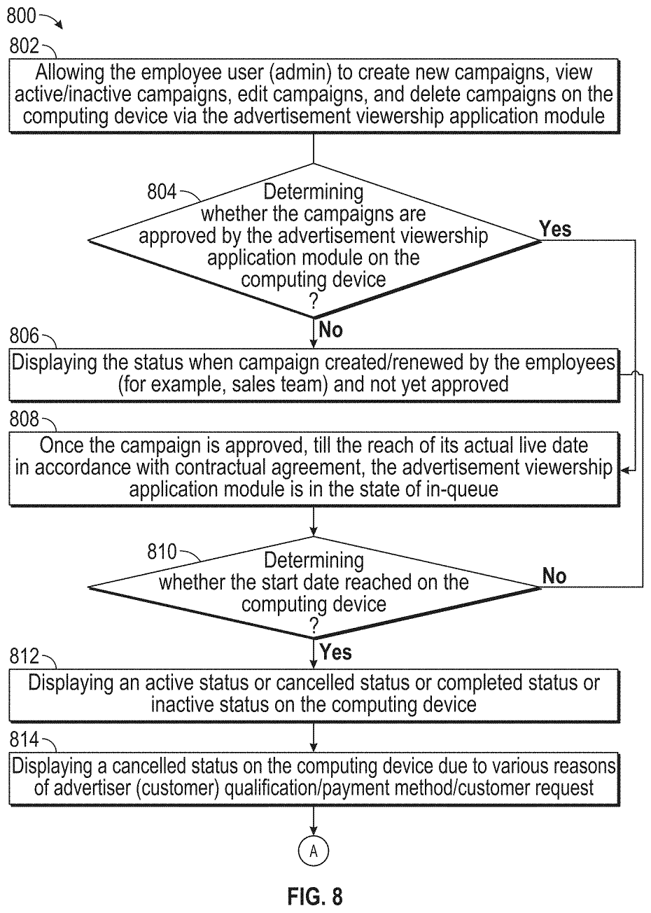

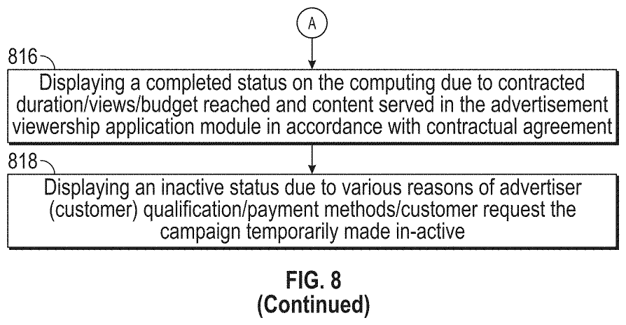

Referring to FIG. 8 is a flowchart 800 depicting an exemplary method for displaying the status on the computing device, in accordance with one or more exemplary embodiments. As an option, method 800 is carried out in the context of the details of FIG. 1, FIG. 2, and FIG. 3, FIG. 4, FIG. 5, FIG. 6, and FIG. 7. However, method 800 is carried out in any desired environment. Further, the aforementioned definitions are equally applied to the description below.

At step 802, the advertisement viewership application module allows the employee (admin) to create new campaigns, view active/inactive campaigns, edit campaigns, and delete campaigns on the computing device. The employee may include, but not limited to, the content management system, admin, manager, English content builder, and so forth. At step 804, the advertisement viewership application module determines whether the campaigns are approved on the computing device. If answer to step 804 is NO, at step 806, the advertisement viewership application module displays the status on the computing device when campaign created/renewed by the employees (for example, sales team) and not yet approved. If answer to step 804 is YES, at step 808, once the campaign is approved, till the reach of its actual live date in accordance with contractual agreement, the advertisement viewership application module is in the state of in-queue. At step 810, the advertisement viewership application module determines whether the start date reached on the computing device. If answer to step 810 is NO, then the method continues at step 806. If answer to step 810 is YES, then the method continues at step 812, the advertisement viewership application module displays an active status or cancelled status or completed status or inactive status on the computing device. At step 814, the advertisement viewership application module displays a cancelled status on the computing device due to various reasons of advertiser (customer) qualification/payment method/customer request. At step 816, displays a completed status on the computing due to contracted duration/views/budget reached and content served in the advertisement viewership application module in accordance with contractual agreement. At step 818, display an inactive status due to various reasons of advertiser (customer) qualification/payment methods/customer request the campaign temporarily made in-active.

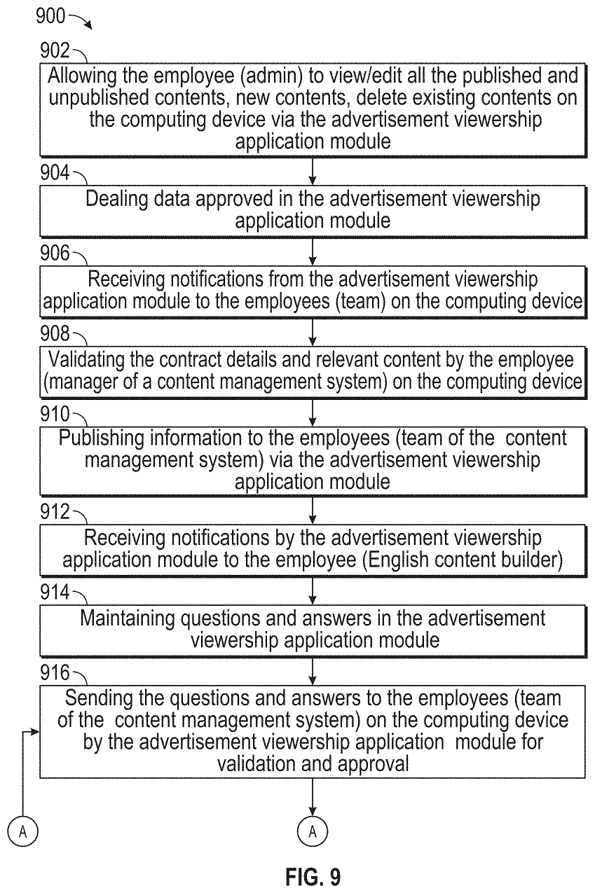

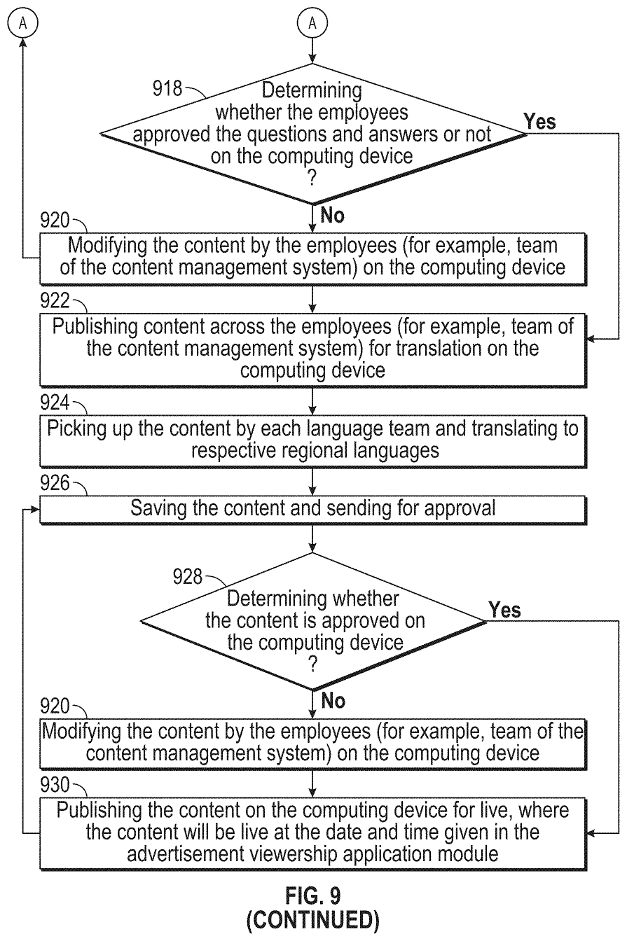

Referring to FIG. 9 is a flowchart 900 depicting an exemplary method for publishing the live content on the computing device, in accordance with one or more exemplary embodiments. As an option, method 900 is carried out in the context of the details of FIG. 1, FIG. 2, and FIG. 3, FIG. 4, FIG. 5, FIG. 6, FIG. 7, FIG. 8. However, method 900 is carried out in any desired environment. Further, the aforementioned definitions are equally applied to the description below.

At step 902, the advertisement viewership application module allows the employee (admin) to view/edit all the published and unpublished contents, new contents, delete existing contents on the computing device. At step 904, the computing device deals data approved in the advertisement viewership application module. At step 906, the employees (team of the content management system) receive notifications from the advertisement viewership application module on the computing device. At step 908, the employee (manager) validates the contract details and relevant content on the computing device. At step 910, the computing device publishes information to the employees (team of the content management system) via the advertisement viewership application module. At step 912, the advertisement viewership application module receives notifications to the employee (English content builder) on the computing device. At step 914, the computing device maintains questions and answers in the advertisement viewership application module. At step 916, the advertisement viewership application module sends the questions and answers to the employees (team of the content management system) on the computing device for validation and approval. At step 918, determine whether the employees approved the questions and answers or not on the computing device. If answer to step 918 is NO, at step 920, the employees (for example, team of the content management system) modify the content on the computing device via the advertisement viewership application module and then method continues at step 916. If answer to step 918 is YES, at step 922, the advertisement viewership application module publishes content across the employees (for example, team of the content management system) for translation on the computing device. At step 924, picks up the content by each language team and translating to respective regional languages. At step 926, the advertisement viewership application module saves the content and sends for approval. At step 928, determine whether the content is approved on the computing device. If answer to step 928 is NO, then the method continues at step 920. If answer to step 928 is YES, at step 930, the computing device publishes the content for live, where the content will be live at the date and time given in the advertisement viewership application module.

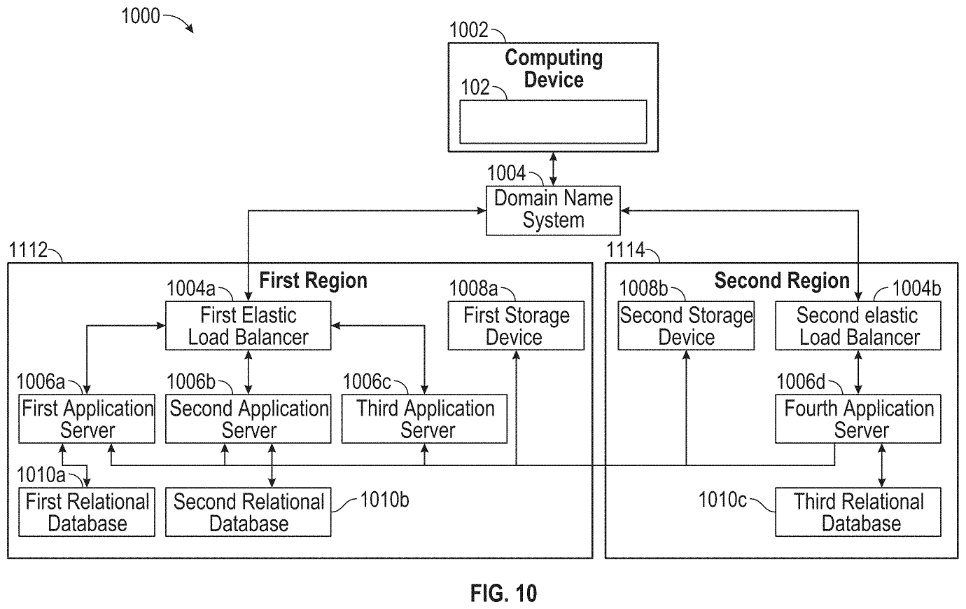

Referring to FIG. 10 is an example system architecture 1000, in accordance with one or more exemplary embodiments. the example system architecture 1000 includes a computing device 1002, a domain name system 1004, a first elastic load balancer 1004a, a second elastic load balancer 1004b, a first application server 1006a, a second application server 1006b, a third application server 1006c, a fourth application server 1006d, a first storage device 1008a, and a second storage device 1008b. The example system architecture 1000 further includes the advertisement viewership application module 102, a first relational database 1110a, and a second relational database 1110b, and a third relational database 1110c. The first elastic load balancer 1004a, the first application server 1006a, the second application server 1006b, the third application server 1006c, the first storage device 1008a, the first relational database 1110a, and the second relational database 1110b may be situated in a first region 1112. Similarly, the second elastic load balancer 1004b, the second application server 1006b, the second storage device 1008b, and the third relational database 1110c may be situated in a second region 1114. The domain name system 1004 may be configured to route traffic between the first region 1112 and the second region 114. The domain name system 1004 may also be configured to build a routing system that uses a combination of geographic location, latency, and availability to route traffic from the users to the cloud or premised endpoints.

The first application server 1006a, the second application server 1006b, the third application server 1006c, and the fourth application server 1006d may be configured to provide scalable computing capacity in the web services cloud. The first application server 1006a, the second application server 1006b, the third application server 1006c, the fourth application server 1006d may also be configured to eliminate the need to invest in hardware up front, enables the users to scale up or down to handle changes in requirements or spikes in popularity, reducing your need to forecast traffic. The first application server 1006a, the second application server 1006b, the third application server 1006c, and the fourth application server 1006d may be configured to ensure that the correct number of application server instances available to handle the load for the application. Each auto scaling group includes maximum number of application servers, and auto scaling ensures that auto scaling group never goes above the size. If the desired capacity is specified, auto scaling ensures that group has many instances. If specify scaling policies, then auto Scaling may launch or terminate instances as demand on the application increases or decreases.

The first elastic load balancer 1004a, and the second elastic load balancer 1004b may be configured to distribute traffic across available application servers 1006a, 1006b, 1006d. the first elastic load balancer 1004a, and the second elastic load balancer 1004b may be configured to may be configured to accept incoming network traffic from a client, and based on certain criteria's in the traffic, the first elastic load balancer 1004a, and the second elastic load balancer 1004b may be configured to distribute those communications out to one or more backend application servers. The first elastic load balancer 1004a, and the second elastic load balancer 1004b may be key to building great internet applications, because gives the redundancy and scalability. The first relational database 1110a, and the second relational database 1110b, and the third relational database 1110c may be configured to provide cost-efficient and resizable capacity while automating time-consuming administration tasks such as hardware provisioning, database setup, patching and backups. The first storage device 1008a, and the second storage device 1008b may be configured to store and access all files/images in scalable way. The first storage device 1008a, and the second storage device 1008b may be configured to host any static content for the advertisement viewership application module 102. The first storage device 1008a, and the second storage device 1008b may have simple web services interface that may use to store and retrieve any amount of data, at any time, from anywhere on the advertisement viewership application module 102. The advertisement viewership application module 102 may be configured to give any developer access to same highly scalable, reliable, fast, inexpensive data storage infrastructure that the servers use to run its own global network of websites. The service aims to maximize benefits of scale and to pass those benefits on to the developers.

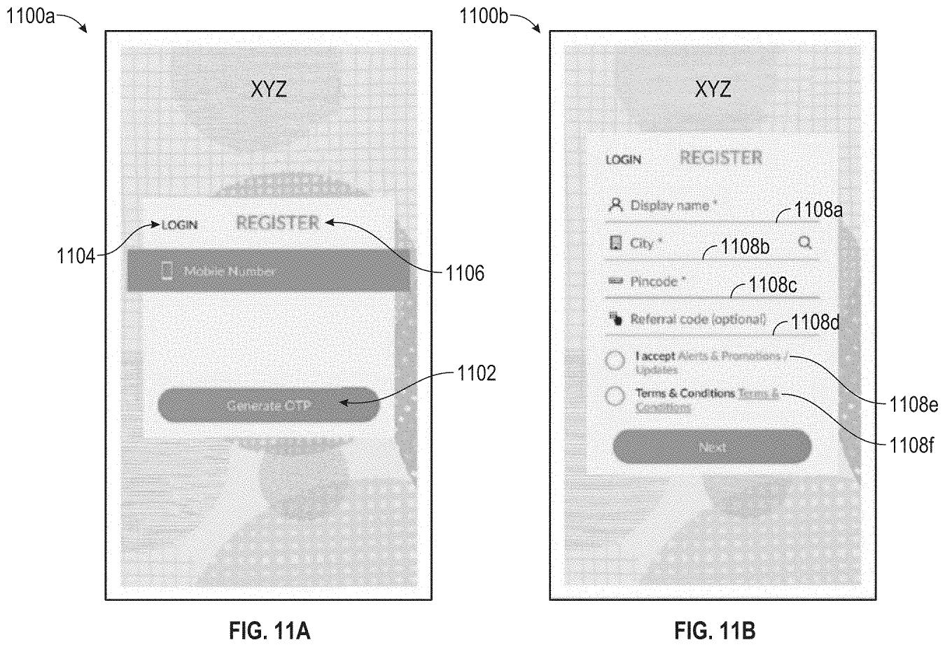

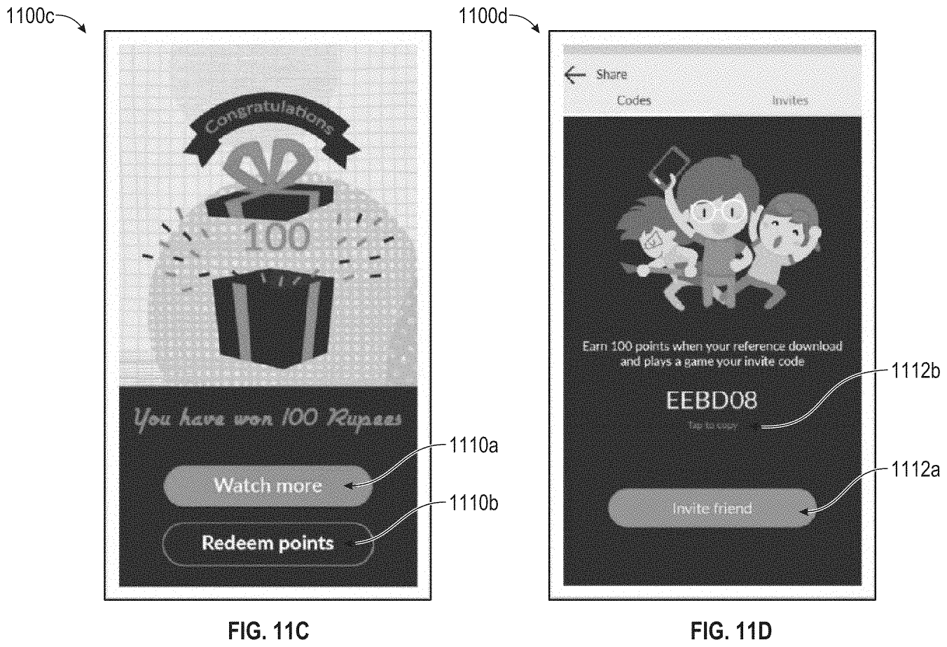

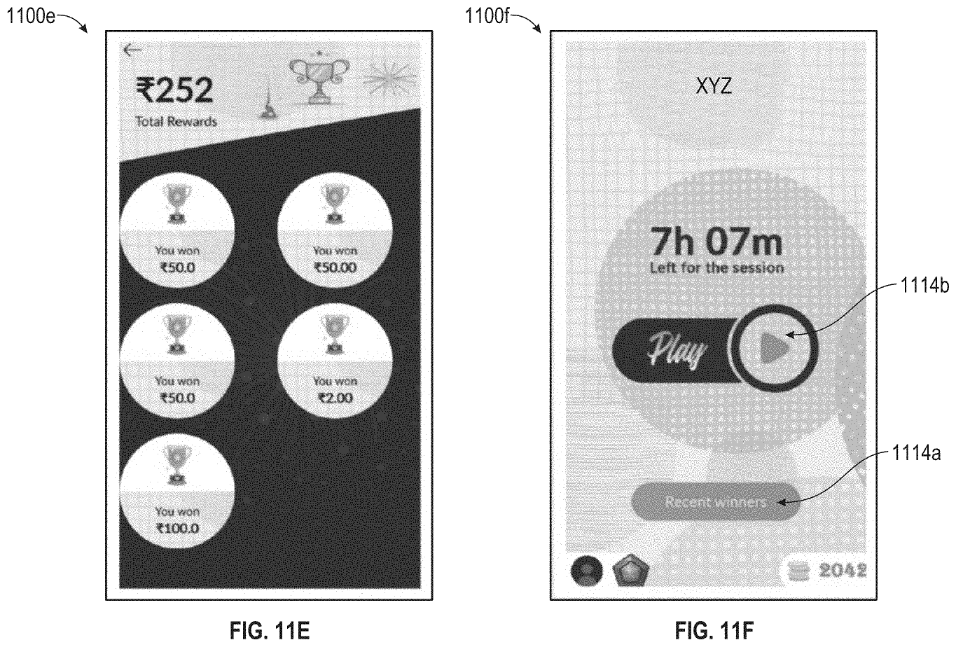

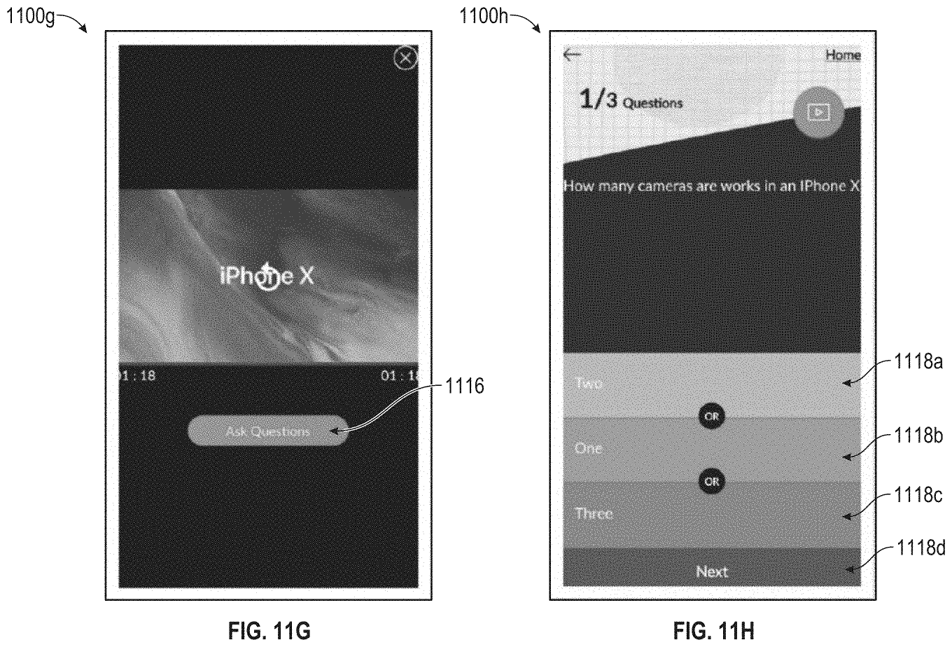

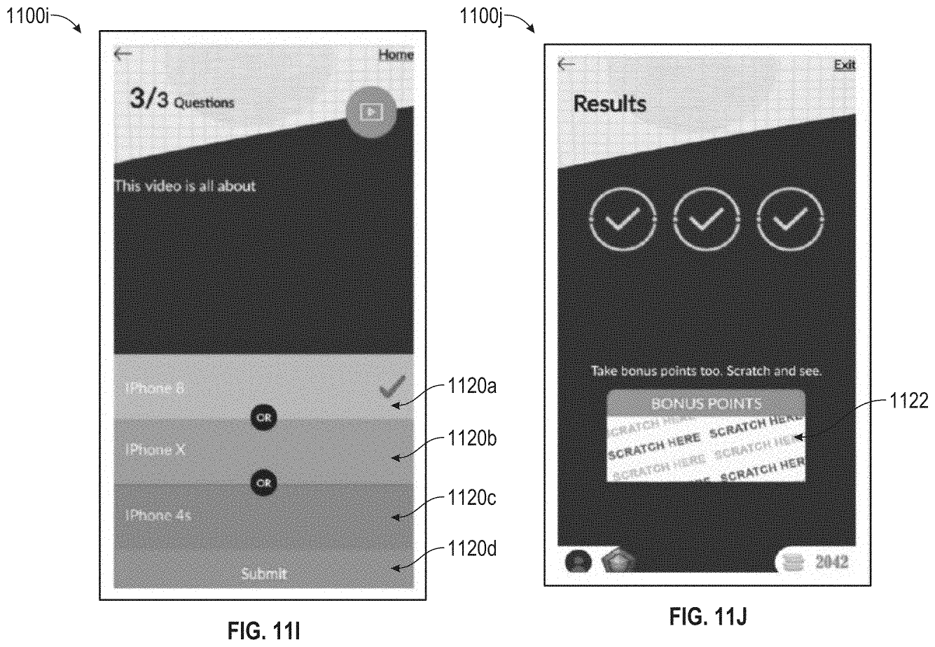

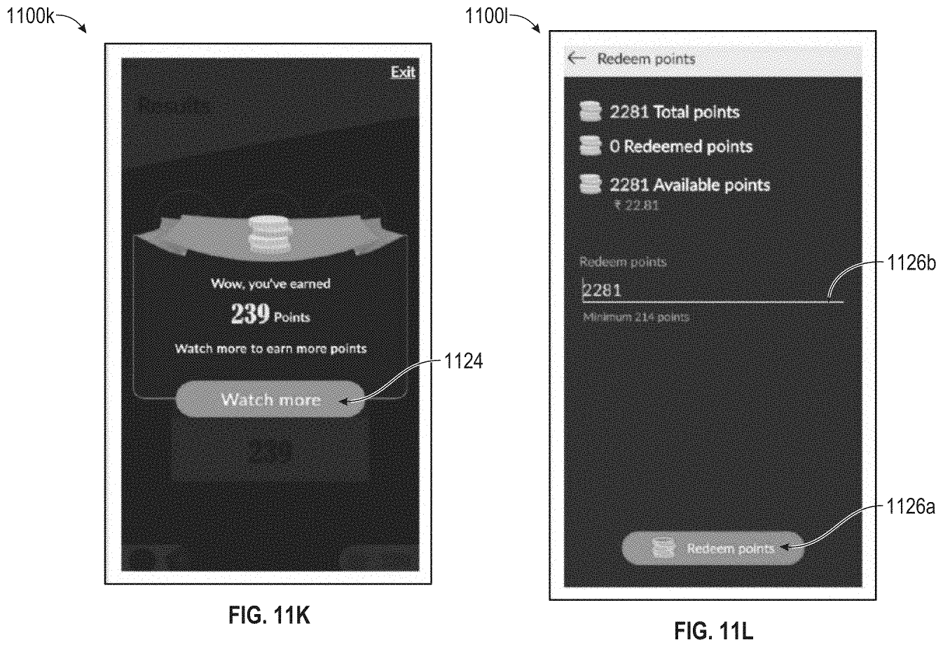

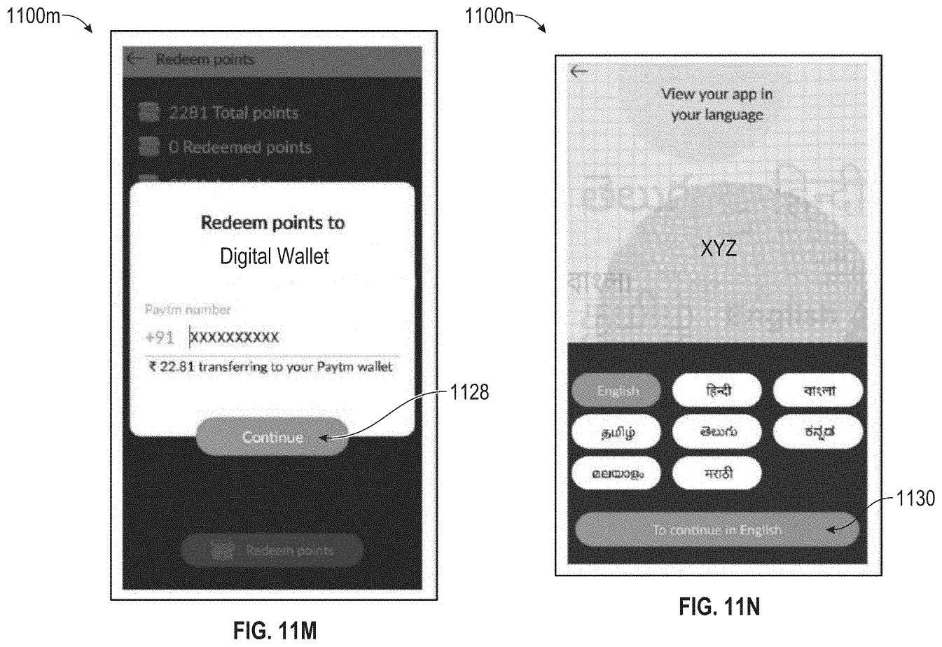

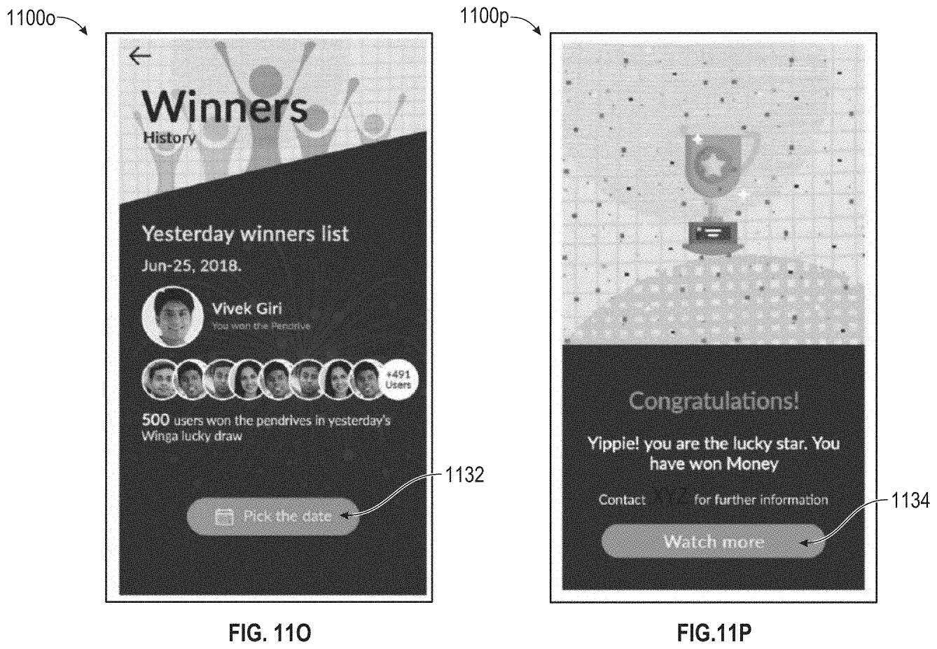

Referring to FIG. 11A-FIG. 11B are example diagrams 1100a-1100b depicting login and registration screens, in accordance with one or more exemplary embodiments. The user has to register before entering into the advertisement viewership application module 102. Post entering the new phone number an OTP may be generated after selecting the generate OTP option 1102. OTP generating is first security layer user to seize any un-authorized logins. If the user has already a registered user, the user may select a login option 1104 to enter into watch and win on the computing device 1002. The registration screen 1100a may also include a re-set password option (not shown) that may enable the user to modify password in case forgets the same. The reset password has the security layer with OTP confirmation to avoid any un-authorized modification of the password. If the user selects the register option 1106, then the screen 1100b may be appeared on the computing device 1002. User registration may be designed to get details related to the user that may be very basic and no personal information may be required to be disclosed. This ensures user not to worry about disclosing common and basic information as identity to the advertisement viewership application module 102. The screen 1100b includes display name option 1108a, a city option 1108b, a pin code option 1108c, a referred code option 1108d, terms and conditions options 1108e, 1108f.

The display name option 1108a, the city option 1108b, the pin code option 1108c, the referred code option 1108d, and terms and conditions options 1108e, 1108f may be configured to make the user easy to enter data. Search option may be provided that may identity the current location of the user through GPS and loads data into city & pin code. However, the user may be warned against accuracy of the pin code (ZIPCODE) & location for better accuracy. The referral code option 1108d may be configured to made optional incase user directly downloads from app store or play store. If user got this from a friend through referral, user may enter the referral code, so that the user may enter the same for additional rewards to the referred. User has to select the terms and conditions options 1108e, 1108f that may be mandatory and optionally the user activates alerts/promotions/updates through a first radio button. This information may be used for MIS reports & other statistics around location based statistics of views, viewership analysis to help providing better viewing experience with relevant ad content near and in the region of the user. This may help users to opt/enjoy & avail discounts, offers, coupons offered by advertisers in the nearby shops/malls/e-commerce portals online. Hence the user may be more engaged to the advertisement viewership application module 102 with its better updates. User may get pre-defined rewards upon installation which may be redeemed through any secured digital wallets or bank accounts if user provides Bank details.

Referring to FIG. 11C is an example diagram 1100c depicting a welcome bonus screen, in accordance with one or more exemplary embodiments. Upon successful registration, the welcome bonus screen 1100c may be appeared on the computing device 1002. The welcome bonus screen 1100c depicts bonus points/amount. The welcome bonus screen 1100c includes a watch more option 1110a, and a redeem points option 1110b. The user has to select the watch more option 1110a to watch one advertisement to get his welcome bonus of configurable amount. The amount may be decided by the business & may vary. This is to make the user acquaint with the app process and encourage him to engage the advertisement viewership application module 102. The redeem points option 1110b may be configured to redeem the installation amount through secured digital wallets. The watch more option 1110a may take the user to home screen to allow the user to watch more videos. Watching more videos may benefit user in two ways such as increase chances of lucky dip wins per session and increase loyalty points to redeem further.

Referring to FIG. 11D is an example diagram 1100d depicting the invite friend screen, in accordance with one or more exemplary embodiments. The invite friend screen 1100d includes an invite friend option 1112a, and a tap to copy option 1112b. Each referral code may make the user earn some money. The reward may be configured from back end and may be redeemed by the user through the digital wallets. The invite friend option 1102a may be configured to enable the user to invite more friends by sharing the referral code through possible means such email communication, SMS, social networking websites, and so forth. The tap to copy option 1112b may be configured to enable the user to copy the referral code. Each user may have a unique share code and may be given across multiple friends. The moment, any user installs the advertisement viewership application module 102 using the referral code and watches first video, the referral bonus may be credited to referrer account within 24 hrs of installation and first video watch and this may be seen in rewards link of the user in the advertisement viewership application module 102. Easy & intuitive screens may be built for clear understanding and navigation may be made simple to move across various screens and come back to home screen very fast without any hassle. All possible levels of information may be provided in the advertisement viewership application module 102 for users.

Referring to FIG. 11E, FIG. 11F, FIG. 11G are example diagrams 1100e, 1100f, 1100g depicting total reward screen and advertisement screens, in accordance with one or more exemplary embodiments. The total reward screen 1100e includes list of rewards. The rewards may be displayed on the computing device 1002 as per date and time. The advertisement screen 1100f includes a recent winner's option 1114a, and a video play option 1114b. The recent winner's option 1114a may be configured to depict the list of winners on the computing device 1002. The video play option 1114b may be configured to enable the user to play the advertisement. Once the user clicks video play option 1114b, the advertisement screen 1100g shows the advertisement in the form of video/banner on the computing device 1002. The advertisement screen 1100g may include an ask question option 1116 configured to depict list of questions on the computing device 1002 if the user clicks the ask question option 1116. The questions may be displayed on the computing device 1002 upon watching each advertisement. The advertisement may be chosen at random from the priority set to serve the video to the user. Questions may be selected to display through un-gues sable random pic. Answers also may follow the random logic topic and may be placed at different locations and in different order. Even if the advertisement is repeated to any of the consecutive users, the probability of matching same set of questions/answers is almost low or nil. In every question, there may a replay option to relook at the Video/Banner advertisement on the computing device 1002 to opt correctly the answer. This gives users to enjoy the watch and win with more ease and navigation.

Referring to FIG. 11H, FIG. 11I, FIG. 11J, FIG. 11K are example diagrams 1100h, 1100i, 1100j, 1100k depicting question screens and result screen, in accordance with one or more exemplary embodiments. The question screens 1100h, 1100i may be displayed on the computing device 1002 if the user clicks the question option 1116. The question screen 1100h may include a question related to the advertisement and corresponding answers 1118a, 1118b, 1118c, and a next button 1118d on the computing device 1002. The user may be allowed to select only one corresponding answer 1118a or 1118b or 1118c on the computing device 1002. If the user selects the next button 1118d on the question screen 1100h, then the question screen 1100i may be displayed on the computing device 1002. The question screen 1100i may include the question related to the advertisement and the corresponding answers 1120a, 1120b, 1120c, and the submit button 1120d. The user may be allowed to select only one corresponding answer 1120a or 1120b or 1120c on the computing device 1002. If the user selects the submit button 1120d, then the answers 1118a or 1118b or 1118c, 1120a or 1120b or 1120c to the questions may be submitted. Once the user completes all answers 1118a or 1118b or 1118c, 1120a or 1120b or 1120c either correctly or incorrectly reward points may be credited to his/her account based on the number of correct answers given on the computing device 1002.

If the user has given all three correct answers, then result screen 1100j may be displayed on the computing device 1002. The result screen 1100j may include a scratch card 1122. Loyalty points may be given through the scratch card 1122 to excite the user with a surprise. If the user has given all three correct answers user may get 100% bonus points decided in the advertisement viewership application module 102. If the user answers only two correct he may be awarded 50% of the bonus points through the scratch card 1122 and if it is only one it may be 33%. Even in case of all wrong answers as well user is given 25% of the decided bonus points through the scratch card 1122 to encourage him to watch more. The screen 1100k depicts earned points and also watch more option 1124. If the user selects the watch more option 1124, then the user may be enabled to watch more videos or advertisements on the computing device 1002.

Referring to FIG. 11L, FIG. 11M are example diagrams 1100l, 1100m depicting redeem point screens, in accordance with one or more exemplary embodiments. The redeem point screen 1100l may include a redeem points button 1126a, and redeem points bar 1126b. The redeem points bar 1126b may be configured to allow the user to enter the required redeem points on the computing device 1002. The user may select the redeem points button 1126a on the computing device 1002 after entering the required redeem points. The redeem point screen 1100m may include a continue button 1128. Redeem points earned by the user throughout engagement with the advertisement viewership application module 102 may be redeemed into the digital wallet after selecting the continue button 1128 on the computing device 1002. The redemption may be full or partial but the user may redeem only when it reaches to a specific level/minimum amount. This is to ensure continued user engagement and considerable amount may excite the user to watch more. In case user has digital wallet ether he may install and sign up the digital wallet or the user may transfer money to other's wallet to get the money. Based on views and continued association with the advertisement viewership application module 102, user may earn more and more points and earn money out of it.

Referring to FIG. 11N is an example diagram 1100n depicting a multi-language support screen, in accordance with one or more exemplary embodiments. The multi-language support screen 1100n includes list of languages. The user may be allowed choose any language from the list of languages. The multi-language support screen 1100n may also include to continue in English button 1130. If the user selects to continue in English button 1130, then the advertisement viewership application module 102 depicts the screens in English. The user may get required language screens as chosen by the user from the list of languages. The multi-language support screen 1100n ensures better user experience and easy to participate in the advertisement viewership application module 102.

Referring to FIG. 11O, FIG. 11P are example diagrams 1100o, 1100p depicting winning screens, in accordance with one or more exemplary embodiments. The winning screen 1100o includes the winners list, and a pick the date button 1132. The user may select the pick the date button 1132 to view the winning list on particular date. After participating in the watch and win contest on the advertisement viewership application module 102, users not only earns installation bonus money, referral bonus money, loyalty points, but also wins exciting prizes (for example, money or any gift) on daily basis through random pick of the users who successfully qualified for this random pic. The advertisement viewership application module 102 may be built to make sure that the winners are selected randomly with proper weightage is given for watching more number of advertisements. However, the chances of winning may be through random pic option only. There may be a variable set to reduce frequent winning of same user due to weightage and loyalty and also any suspicious, abnormal user behaviors can be caught through the advertisement viewership application module 102. The winning screen 1100p includes the congratulation message and the watch more button 1134. If the user selects the watch more button 1134, then the user may be allowed to watch more videos on the computing device 1002.

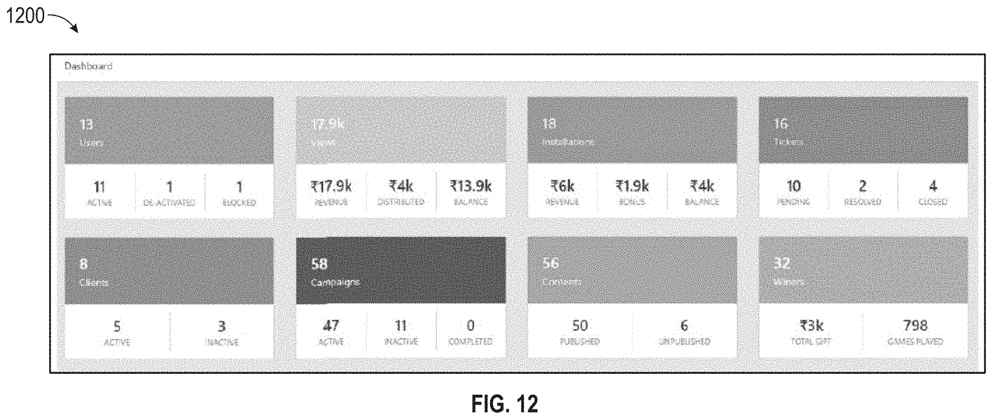

Referring to FIG. 12, FIG. 12 is an example diagram 1200 depicting the real time cumulative figures dashboard screen, in accordance with one or more exemplary embodiments. The real time cumulative figures dashboard screen 1200 includes number of users, number of clients, number of views, number of campaigns, number of installations, number of contents, number of tickets, number of winners, and so forth. The number of users may include active users, deactivated users, blocked users, and so forth. The number of clients may include active clients, and inactive clients. The number of campaigns may include active campaigns, inactive campaigns, and completed campaigns. The number of installations may include a revenue amount, a bonus amount, and a balance amount. The number of tickets may include pending tickets, resolved tickets, and closed tickets. The number of contents may include published contents and unpublished contents. The number of winners may include total gift amount and games played.

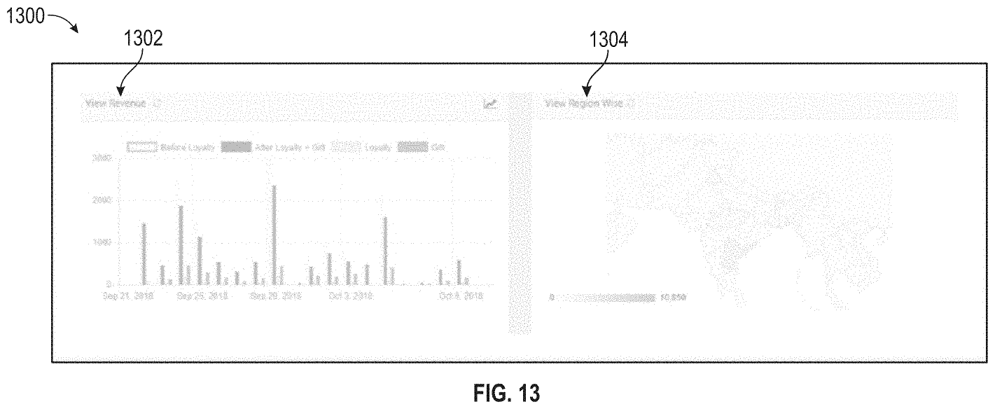

Referring to FIG. 13, FIG. 13 is an example diagram 1300 depicting the views region wise screen, in accordance with one or more exemplary embodiments. The views region wise screen 1300 includes a view revenue option 1302, and a view region wise option 1304. If the user selects the view revenue option 1302 on the computing device 1002, then the graph may be represented with loyalty points (before loyalty points, after loyalty points), and gifts. If the user selects the view region wise option 1304, then the regions may be highlighted on the computing device 1002. The highlighted regions may represent the earned revenue and/or gifts.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for achieving viewer response/acknowledgement based digital advertising using the cloud service platform, comprising:
a plurality of computing devices connected with an advertisement viewership application module through a communication network, whereby the advertisement viewership application module receives a plurality of requests from the plurality of computing devices and the advertisement viewership application module comprises at least one I/O interface configured to receive one or more input data from the plurality of computing devices through the communication network, at least one memory configured to store the information received from the at least one I/O interface and the at least one memory communicatively coupled to the at least one processor of the advertisement viewership application module, characterized in that:
the advertisement viewership application module configured to display one or more digital contents on the plurality of computing devices, the advertisement viewership application module configured to provide a plurality of questions associated with one or more digital contents based on the authentication of the plurality of users and receives a plurality of answers for the question from the plurality of users and checks for the correctness of the plurality of answers.

2. The system of claim 1, wherein the advertisement viewership application module comprises a first elastic load balancer and a second elastic load balancer configured to distribute traffic across a plurality of application servers.

3. The system of claim 2, wherein the plurality of application servers configured to provide scalable computing capacity in a web services cloud.

4. The system of claim 2, wherein the first elastic load balancer and the second elastic load balancer configured to accept the traffic from the plurality of computing devices based on certain criteria's in the traffic.

5. The system of claim 1, wherein the at least one memory also configured to store processor instructions which causes the processor to execute the instructions for obtaining complete viewership associated with the one or more digital contents.

6. The system of claim 1, wherein the advertisement viewership application module comprises an input module configured to receive input data from the plurality of computing devices, where the input data comprises at least one of user registration data, user authenticity, user selected data, user answers to questions display on the plurality of computing devices and any other user data.

7. The system of claim 1, wherein the advertisement viewership application module comprises a processing module processes the user input data provides at least one of: registration; authenticity; checking the correctness of the plurality of answers to the plurality of questions; and verifying any data associated with the plurality of users.

8. The system of claim 1, wherein the advertisement viewership application module comprises an analytics module configured to provide analytics associated with the user data on the plurality of computing devices.

9. The system of claim 1, wherein the advertisement viewership application module comprises an output module configured to provide a plurality of outputs to the plurality of computing devices.

10. A method for achieving viewer response/acknowledgement based digital advertising using the cloud service platform, comprising:
displaying one or more digital contents on one or more computing devices, whereby the one or computing devices configured with an advertisement viewership application module, whereby advertisement viewership application module comprises at least one memory configured to store processor instructions which causes at least one processor to execute the instructions for obtaining complete viewership associated with the one or more digital contents, the advertisement viewership application module receives a plurality of requests from the one or more computing devices and the advertisement viewership application module comprises at least one I/O interface configured to receive an input data from the one or more computing devices through a communication network;
verifying the input data for authentication by the advertisement viewership application module on the one or more computing devices, whereby the one or more computing devices comprises a first elastic load balancer and a second elastic load balancer configured to distribute traffic across a plurality of application servers;
providing a plurality of questions related to the one or more digital contents by the advertisement viewership application module based on the authentication of the one or more users;
receiving a plurality of answers for the plurality questions from the one or more computing devices and checking for the correctness of the plurality of answers by the advertisement viewership application module; and
verifying the plurality of questions provided with the one or more users by advertisement viewership application module on the one or more computing devices, whereby the one or more computing devices requests the one or more users to continue the plurality of questions based on the input data.
